(19) United States
(12) Patent Application Publication
(10) Pub. No.: US 2026/0063179 A1
(43) Pub. Date: Mar. 5, 2026

(54) PIVOTABLE STRUT COUPLER AND PIVOTABLE STRUT RETAINER

(71) Applicant: Means Industries, Inc., Saginaw, MI (US)

(72) Inventors: Douglas Brubaker, Midland, MI (US); Brice Pawley, Midland, MI (US); Jipeng Fan, Fairfax, VA (US)

(21) Appl. No.: 19/294,490

(22) Filed: Aug. 8, 2025

Related U.S. Application Data
(60) Provisional application No. 63/691,210, filed on Sep. 5, 2024.

(51) Int. Cl. F16D 63/00; F16D 65/16; F16D 121/22

(52) U.S. Cl. CPC F16D 63/006; F16D 65/16; F16D 2121/22

(57) ABSTRACT

A strut retainer may include strut ear retainers at least partially defined by weakenings to facilitate resilient flexure. A pivotable strut coupler may include a housing, a strut carried by the housing, and a strut retainer coupled to the housing and straddling transversely across a portion of the strut. The housing includes a strut pocket in a base surface and having a transverse pocket portion extending transversely with respect to at least one of a forward pocket portion or a rearward pocket portion of the housing along a transverse axis. The strut is carried in the strut pocket and includes ears extending in directions transversely away from sides of the strut and carried in a transversely extending transverse pocket portion of the strut pocket. The strut retainer straddles the portion of the strut including the ears, and includes weakenings to facilitate resilient flexure of the strut retainer.

### TECHNICAL FIELD

This disclosure relates generally to couplings for transmitting rotation and, more particularly, to pivotable strut couplers and strut retainers.

### BACKGROUND

Some types of rotational couplings include a rotatable notch member having a circumferential array of notches, a pocket member having one or more pockets to receive one or more pivotable struts that are passively or actively displaceable into corresponding notches of the notch member to couple the notch member to the pocket member against relative rotation therebetween. Some such rotational couplings are radial couplings having radially opposed notches and pockets in radial notch and pocket members, whereas other such rotational couplings are planar couplings having axially opposed notches and pockets in planar notch and pocket members. Some pocket members are disc-shaped or annular-shaped and have a circumferential array of pockets carrying a corresponding circumferential array of struts, whereas other pocket plates are plug-shaped and have a single pocket carrying a corresponding single strut and are known as a single strut insert (SSI). Many pocket members also carry strut retainers that may be used to retain the struts in their pockets. Unfortunately, when a rotational coupling fails under excessive loading or when a failure or displacement of adjacent parts occurs, the struts may pivot beyond a design-intent angle and break the strut retainers, thereby releasing unwanted debris in the rotational coupling or permitting the struts to fall out of the pockets.

### SUMMARY

An illustrative embodiment of a pivotable strut coupler includes a housing, a strut carried by the housing, and a strut retainer coupled to the housing and straddling transversely across a portion of the strut. The housing includes a base surface, and a strut pocket in the base surface and having a forward pocket portion extending along a longitudinal axis, a rearward pocket portion extending along the longitudinal axis, and a transverse pocket portion extending transversely with respect to at least one of the forward pocket portion or the rearward pocket portion along a transverse axis. The strut is carried in the strut pocket of the housing and includes a forward body portion carried in the forward pocket portion of the strut pocket of the housing, a rearward body portion carried in the rearward pocket portion of the strut pocket of the housing, sides, and ears extending in directions transversely away from the sides and carried in the transversely extending transverse pocket portion of the strut pocket of the housing. The strut retainer straddles across the portion of the strut including the ears, and includes weakenings to facilitate resilient flexure of the strut retainer.

An illustrative embodiment of a pivotable strut retainer includes strut ear retainers including laterally opposed edges establishing a pivotable strut opening, a strut body retainer including a front edge transversely extending between the laterally opposed edges of the strut ear retainers, and weakenings at least partially defining the strut ear retainers to facilitate resilient flexure of the strut ear retainers.

### BRIEF DESCRIPTION OF THE DRAWINGS

FIG. 1 shows an upper perspective view according to an illustrative embodiment of a pivotable strut coupler having a housing, a pivotable strut carried in the housing, a strut retainer coupled to the housing and straddling a portion of the pivotable strut, and a solenoid to actuate the strut.

FIG. 2 shows a lower perspective view of the pivotable strut coupler of FIG. 1 including the solenoid coupled to the housing.

FIG. 3 shows an enlarged, fragmentary, lower perspective view of the pivotable strut and retainer of FIG. 1.

FIG. 4 shows an enlarged upper perspective view of the housing of the pivotable strut coupler of FIG. 1.

FIG. 5 shows an enlarged plan view of the housing of the pivotable strut coupler of FIG. 1.

FIG. 6 shows an enlarged longitudinal cross-sectional view of the housing of the pivotable strut coupler on FIG. 1.

FIG. 7 shows a longitudinal cross-section of the pivotable strut coupler of FIG. 1, wherein the strut is advanced to an engaged position with a notch member.

FIG. 8 shows a longitudinal cross-section of the pivotable strut coupler of FIG. 1, wherein the strut is retracted to a disengaged position with respect to the notch member.

FIG. 9 shows a plan view of the pivotable strut coupler of FIG. 1.

FIG. 10 shows an enlarged, fragmentary, side view of the pivotable strut and retainer of FIG. 1, wherein the pivotable strut is in the engaged position.

FIG. 11 shows an enlarged, fragmentary, side view of the pivotable strut and retainer of FIG. 1, wherein the pivotable strut is in a hyperextended position and the strut retainer is shown in a deflected position.

FIG. 12 shows an upper perspective view according to another illustrative embodiment of a pivotable strut coupler having a housing, a pivotable strut carried in the housing, a strut retainer according to another illustrative embodiment coupled to the housing and straddling a portion of the pivotable strut, and a solenoid to actuate the strut.

FIG. 13 shows a plan view of the pivotable strut coupler of FIG. 12.

FIG. 14 shows an enlarged, fragmentary, lower perspective view of the pivotable strut and retainer of FIG. 12.

FIG. 15 shows a plan view of according to a further illustrative embodiment of a pivotable strut coupler having a strut retainer according to a further illustrative embodiment.

FIG. 16 shows an enlarged upper perspective view of the strut retainer of FIG. 15.

FIG. 17 shows an enlarged upper perspective view according to an additional embodiment of a strut retainer.

### DETAILED DESCRIPTION

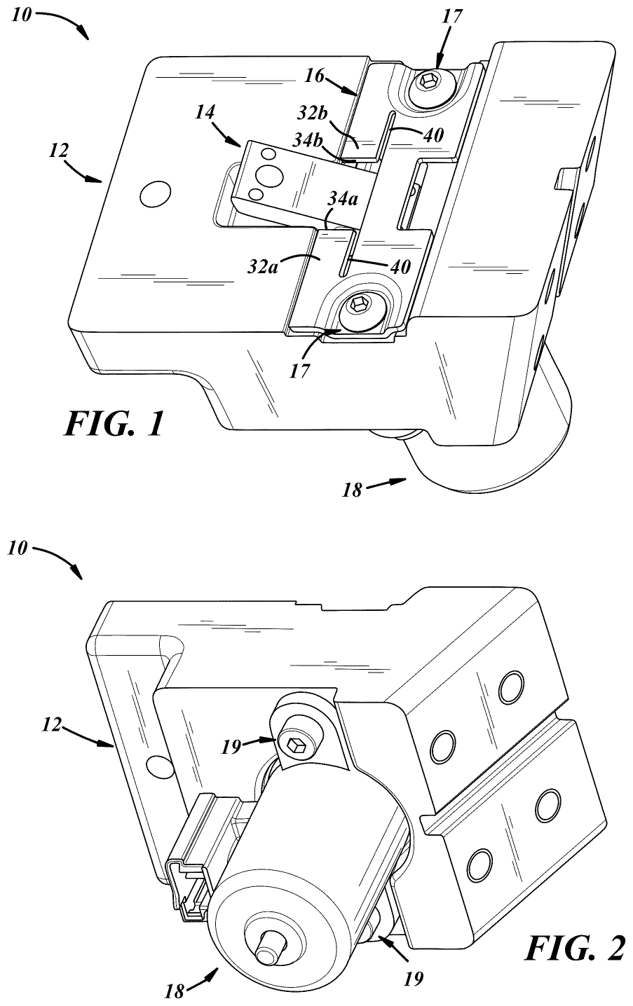

Referring specifically to the drawings, FIGS. 1 and 2 show an illustrative embodiment of a pivotable strut coupler 10 that may be used to selectively engage with, and/or selectively disengage, from a rotatable component (not shown), for instance, a clutch race, a clutch plate, or other clutch component, a gear, a flywheel, or any other rotatable component. The pivotable strut coupler includes a housing 12, a strut 14 (FIG. 1) carried by the housing 12, and a strut retainer 16 (FIG. 1) coupled to the housing 12 and straddling transversely across a portion of the strut 14. The pivotable strut coupler 10 also may include an actuator 18 that may be coupled to the housing 12, for instance, an electromechanical actuator, more specifically, an electromechanical solenoid. In other embodiments, the actuator 18 may include a pneumatic actuator, a hydraulic actuator, or any other type of actuator suitable for use with couplings for transmitting rotation. The pivotable strut coupler 10 also may include retainer fasteners 17 (FIG. 1) to fasten the strut retainer 16 to the housing 12, and actuator fasteners 19 (FIG. 2) to fasten the actuator 18 to the housing 12. Although the illustrated pivotable strut coupler 10 is shown as being a single strut insert (SSI) type of device, it is also contemplated that other types of devices could be used. For example, and although not illustrated, the pivotable strut coupler 10 may take the form of a pocket plate type of device including a pocket plate having a circumferential array of pockets carrying a circumferential array of pivotable struts that may be actuated by plungers coupled to a common actuator plate that may be actuated by one or more electric, pneumatic, and/or hydraulic actuators, or any other type of actuator(s) suitable for use with couplings for transmitting rotation. Additionally, although the pivotable strut coupler 10 is illustrated as being a unidirectional device that engages another clutch component in only one circumferential direction, it is contemplated that the pivotable strut coupler 10 could be a bidirectional device that engages another clutch component in opposite circumferential directions, either individually to lock against relative rotation in one circumferential direction or in tandem to lock against relative rotation in both circumferential directions. Likewise, multiple instances of the pivotable strut coupler 10 could be deployed in opposite circumferential orientations to engage another clutch component in opposite circumferential directions.

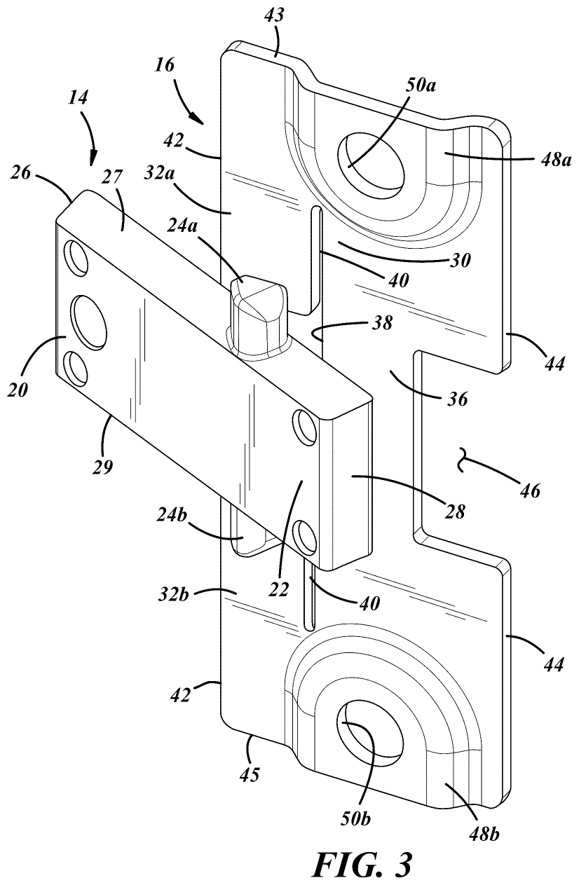

With reference now to FIG. 3, the strut 14 may be oblong, for example, rectangular, and may extend along a longitudinal axis of the strut 14. The strut 14 may include a forward strut portion 20, a rearward strut portion 22, and ears 24a,b extending in directions transversely away from the forward and rearward strut portions 20, 22. The forward strut portion 20 of the strut 14 may include a forward engagement face 26, and the rearward strut portion 22 of the strut 14 may include a rearward engagement face 28. The ears 24a,b may extend in directions transversely away from the sides 27, 29 of the strut 14 along a transverse pivot axis. Although the widths between the sides 27, 29 at the forward and rearward strut portions 20, 22 are shown as being identical, the widths may be different.

With continued reference to FIG. 3, the strut retainer 16 may be oblong, for example, rectangular, and may extend along a transverse axis of the strut retainer 16 that may be orthogonal or perpendicular to the longitudinal axis of the strut 14. The strut retainer 16 may include a plate portion 30 that may include strut ear retainers 32a,b including laterally opposed edges 34a,b (FIG. 1) that may face one another in an inboard direction and that establish a pivotable strut opening. The strut retainer 16 may include a strut body retainer 36 extending transversely between the strut ear retainers 32a,b and including a front edge 38 transversely extending between the laterally opposed edges 34a,b of the pivotable strut ear retainers 32a,b. The strut retainer 16 also includes weakenings 40 that may bound or at least partially define the strut ear retainers 32a,b to facilitate resilient flexure or deflection of the pivotable strut ear retainers 32a,b away from their rest positions shown on FIGS. 1 and 3. The weakenings 40 are illustrated in the drawing figures as slots, but could be perforations, thinnings or thin-walled portions, notches, gaps, or any other weakened portions of the strut retainer 16 suitable to facilitate resilient flexure, for example, elastic deformation, of the strut ear retainers 32a,b. The weakenings 40 may be linear, for example, straight lines as shown, may be of consistent width as shown, may be orthogonal as shown or may be oblique at 45-degree angles or any other suitable oblique angles, or of any other geometry suitable to facilitate resilient flexure, for example, elastic deformation, of the strut ear retainers 32a,b. In any case, the strut ear retainers 32a,b are at least partially defined by the weakenings 40 between the strut ear retainers 32a,b and other portions of the strut retainer 16. The strut retainer 16 also may include a forward edge 42 interrupted by the laterally opposed edges 34a,b of the ear retainers, a rearward edge 44 that may be interrupted by a rear relief 46 that may provide an opening to vent material, for example, debris, away from the pocket/strut, and side edges 43, 45 extending between the forward and rearward edges 42, 44. The strut retainer 16 also may include fastener bosses 48a,b, and fastener passages 50a,b therethrough. The fastener bosses 48a,b may extend in a direction away from the plate portion 30 toward the strut 14. As used herein, the base term “retain” is synonymous with the base terms “contain” and “cover” and includes a holding or securing of the strut 14 relative to the housing 12.

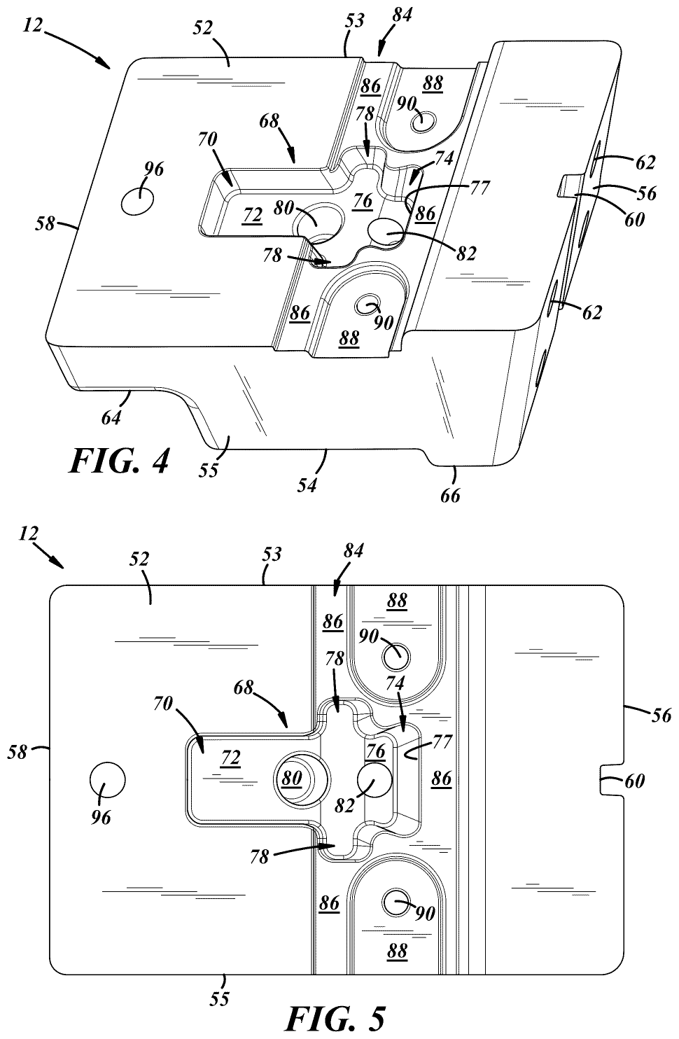

With reference to FIGS. 4 through 6, the housing 12 may include a base surface 52, an actuator mounting surface 54 axially opposite of the base surface 52, side surfaces 53, 55 extending away from the base surface 52 between the base surface 52 and the actuator mounting surface 54, a rear surface 56 extending between the side surfaces 53, 55, and a front surface 58 extending between the side surfaces 53, 55. The rear surface 56 may include a mounting slot 60 and one or more fastener passages 62 (FIG. 4) therein. The housing 12 also may include a relief step surface 64 extending between the side surfaces 53, 55 at a location forward of the actuator mounting surface 54, and a projection step surface 66 extending between the side surfaces 53, 55 at a location rearward of the actuator mounting surface 54.

The housing 12 also includes a strut pocket 68 that may be recessed in the base surface 52. The strut pocket 68 may be oblong and may extend along a longitudinal axis of the strut pocket 68. The strut pocket 68 may include a housing forward portion 70 to accommodate the forward strut portion 20 of the strut 14 (FIG. 3) and having a forward bottom surface 72, a housing rearward portion 74 to accommodate the rearward strut portion 22 of the strut 14 (FIG. 3) and having a rearward bottom surface 76 and a strut reaction surface 77 extending away from the rearward bottom surface 76, and a transverse portion 78 to accommodate the ears 24a,bof the strut 14. The housing 12 further includes a spring pocket 80 in the forward bottom surface 72 of the housing forward portion 70 of the strut pocket 68, and an actuator armature passage 82 through the rearward bottom surface 76 of the housing rearward portion 74 of the strut pocket 68. The actuator armature passage 82 may be a through hole to carry an actuator plunger therein that may impose a strut-retracting force on the strut 14, whereas the spring pocket 80 may be a blind hole to carry a strut spring therein that may impose a strut-advancing force on the strut 14 when not being counteracted by the actuator. In another embodiment, not illustrated, a spring pocket may be provided in a rearward bottom surface of a housing rearward portion of a strut pocket and an actuator armature passage may be provided through a forward bottom surface of a housing forward portion. In such an embodiment, of course, a spring would be located in the spring pocket to bias a strut to a disengaged position and an actuator would be cooperative with the actuator armature passage to bias the strut to an engaged position.

The housing 12 also includes a strut retainer pocket 84. The strut retainer pocket 84 may be oblong, may intersect the strut pocket 68, and may extend along a transverse axis that may be orthogonal or perpendicular with respect to the longitudinal axis of the strut pocket 68. The strut retainer pocket 84 may include a strut retainer bottom surface 86 against which the plate portion 30 of the strut retainer 16 may be mounted, retainer debossments 88 in which the fastener boss portions 48a,b of the strut retainer 16 (FIG. 3) may be located, and fastener passages 90 in the strut retainer debossments 88 to accept retainer fasteners 17 (FIG. 1).

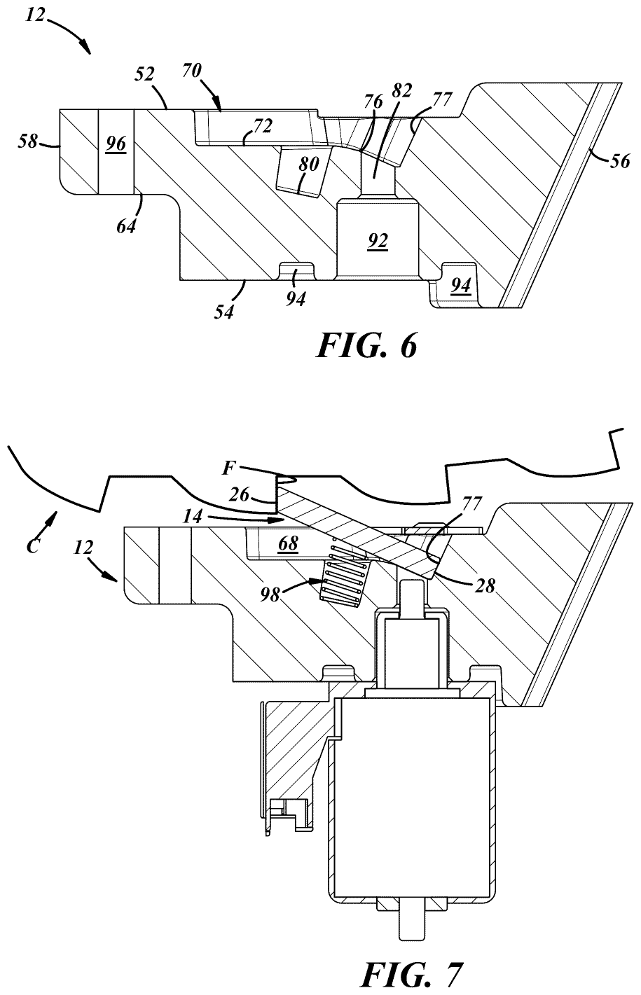

As shown on FIG. 6, the housing 12 also may include an actuator pocket 92 in the actuator mounting surface 54 to accommodate a portion of an actuator. Also, the housing 12 may include actuator fastener passages 94 in the actuator mounting surface 54 to accommodate actuator fasteners (not shown). Additionally, the housing 12 may include a housing fastener through passage 96 in the base surface 52, for example, all the way through to the relief step surface 64, to accommodate housing fasteners (not shown).

With reference now to FIG. 7, the pivotable strut coupler 10 is shown engaged to another coupling component C, such as a flywheel of an engine, as an implementation example for illustrative purposes only. More specifically, the housing 12 of the pivotable strut coupler 10 may be fastened or otherwise coupled to an inside portion of a bell housing of a transmission (not shown) that is coupled to the engine. The forward engagement face 26 of the strut 14 is shown in contact with a corresponding engagement face F of a notch, tooth, or the like of the other coupling component C, and the rearward engagement face 28 of the strut 14 is shown in contact with the corresponding reaction surface 77 of the strut pocket 68 of the housing 12. The pivotable strut coupler 10 also may include a spring 98 to normally bias the strut 14 toward its advanced position extending out of the strut pocket 68. The spring 98 may counteract oil flow forces around the strut 14, G-forces from vibration, or any other force(s) that may cause the strut 14 to tend to move to the engaged position As used herein, the term “spring” includes one or more coil springs as illustrated, one or more torsional springs, one or more resilient members, or any other biasing device or means for biasing the strut 14.

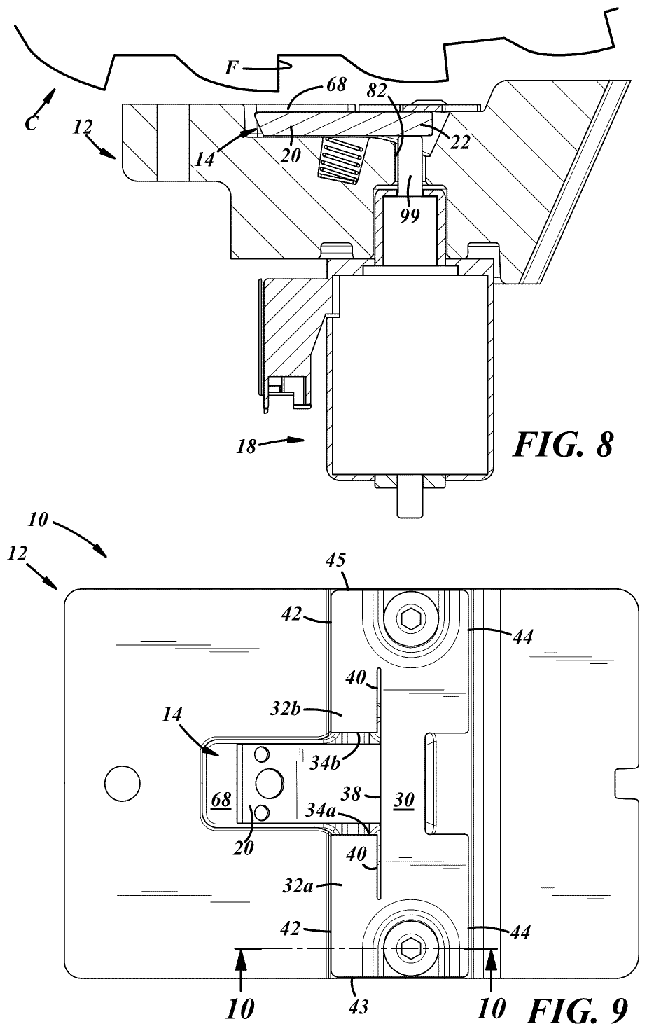

With reference now to FIG. 8, the pivotable strut coupler 10 is shown disengaged from the other coupling component C. The actuator 18 is shown in an actuated position wherein an armature 99 of the actuator 18 is shown in an advanced position in the armature passage 82 of the housing 12 and engaged against the rearward strut portion 22 of the strut 14. In this state, the armature 99 pivots the strut 14 about the transverse pivot axis extending through the ears (FIG. 3) of the strut 14 so that the forward strut portion 20 of the strut 14 is moved into the strut pocket 68 toward the bottom surface 72 (FIG. 6) of the housing forward portion 70 of the strut pocket 68 against a bias force offered by the spring 98. In this position, the other component C (e.g. flywheel) may rotate with respect to the pivotable strut coupler 10 and, for example, relative to the transmission housing.

With reference now to FIG. 9, the strut 14 is shown in its advanced position wherein the forward strut portion 20 of the strut 14 extends outwardly from the strut pocket 68 of the housing 12. The weakenings 40 may originate at junctions between the laterally opposed edges 34a,b of the strut ear retainers 32a,b and the front edge 38 of the strut body retainer 36. The weakenings 40 may be located laterally about one-third of the distance between the forward edge 42 and the rearward edge 44. In a more specific example, the weakenings 40 may be located longitudinally between 25% and 50% of the distance from the forward edge 42 to the rearward edge 44 or, more specifically, between 35% and 40% of that distance. Also, or instead, the weakenings 40 may be configured so that the retainers 32a,b may overlap the strut ears 100% to 130%, for example. The weakenings 40 may extend laterally from the laterally opposed edges 34a,b of the strut ear retainers 32a,b toward the side edges 43, 45 and may terminate at about half way between the laterally opposed edges 34a,b and the side edges 43, 45. More specifically, the weakenings 40 may extend laterally between 20% and 80% of the distance from the laterally opposed edges 34a,b to the side edges 43, 45 or, more specifically, between 30% and 70% of that distance or, even more specifically between 40% and 60% of that distance.

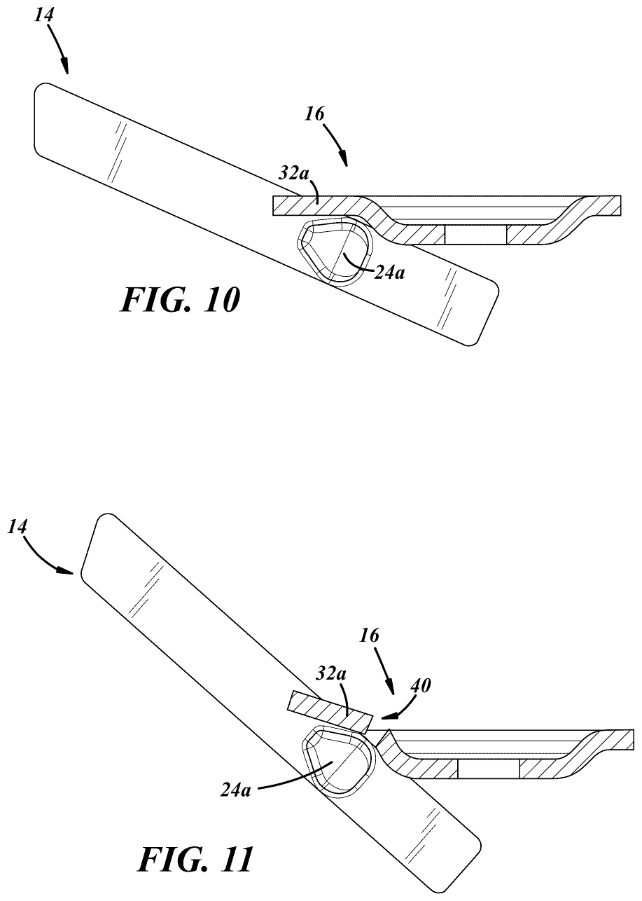

With reference now to FIG. 10, the strut 14 is shown in its advanced position of FIG. 9 specifically with reference to the strut retainer 16, and illustrating the strut ear retainers 32a relative to the ears 24a of the strut 14 and in their rest positions. As shown on FIG. 10, the ears 24a may be ovular or pear-shaped in end-views and in cross-sections by planes parallel to the longitudinal axis of the strut 14.

With reference now to FIG. 11, the strut 14 is shown in a hyperextended position relative to the strut retainer 16, and illustrating the strut ear retainers 32a (only one shown on FIG. 11) displaced, deflected, or deformed by the ears 24a of the strut 14. The weakenings 40 allow the strut ear retainers 32a to bend but not break. In fact, the weakenings 40 may allow the strut ear retainers 32a to deform elastically but not plastically in many if not all potential hyperextension conditions of the strut 14. In cases where a hyperextension of a strut 14 is severe enough to plastically deform the strut ear retainers 32a, the weakenings 40 help curtail such plastic deformation and facilitate resilient and substantial return of the strut ear retainers 32a back to or toward their rest positions (even if not fully and completely back to their rest positions) after hyperextension of the strut 14. This means that the return of the strut ear retainers 32a is to an extent that allows the strut ear retainers 32a to continue to retain the strut 14, for example, to a degree that meets performance specifications for a particular application. In a more specific example, this may mean that the weakenings 40 may facilitate elastic deformation of the strut ear retainers 32a of at least 60% recovery of the strut ear retainers 32a back toward their rest position, or between 60% and 100% recovery back toward their rest position, more particularly between 70% and 100% recovery back toward their rest position, even more particularly between 80% and 100% recovery back toward their rest position, and yet more particularly between 90% and 100% recovery back toward their rest position. After hyperextension of the strut 14, the strut 14 returns to its normal extended position engaged against the other component or to its retracted position within its respective strut pocket or the like. For example, when the strut 14 is returned to its advanced position, the strut ear retainers 32a return to their rest positions as shown on FIG. 10 and continue to retain the strut 14. The strut ear retainers 32a,b retain the strut 14 and provide reaction surfaces for the strut 14 when the actuator 18 disengages the strut 14 by pushing a portion of the strut 14 toward the retainer 16, wherein the strut 14 contacts the retainer 16 in several places, including the rearward portion of the strut 14 and the ears 24a,b of the strut 14. The retainer 16 reacts the force imposed by the actuator 18, and the strut ear retainers 32a,b are sufficiently strong to not deflect as the retainer 16 reacts the actuator force during disengagement but sufficiently weak to deflect under hyperextension of the strut 14 during excessive strut loading and the like.

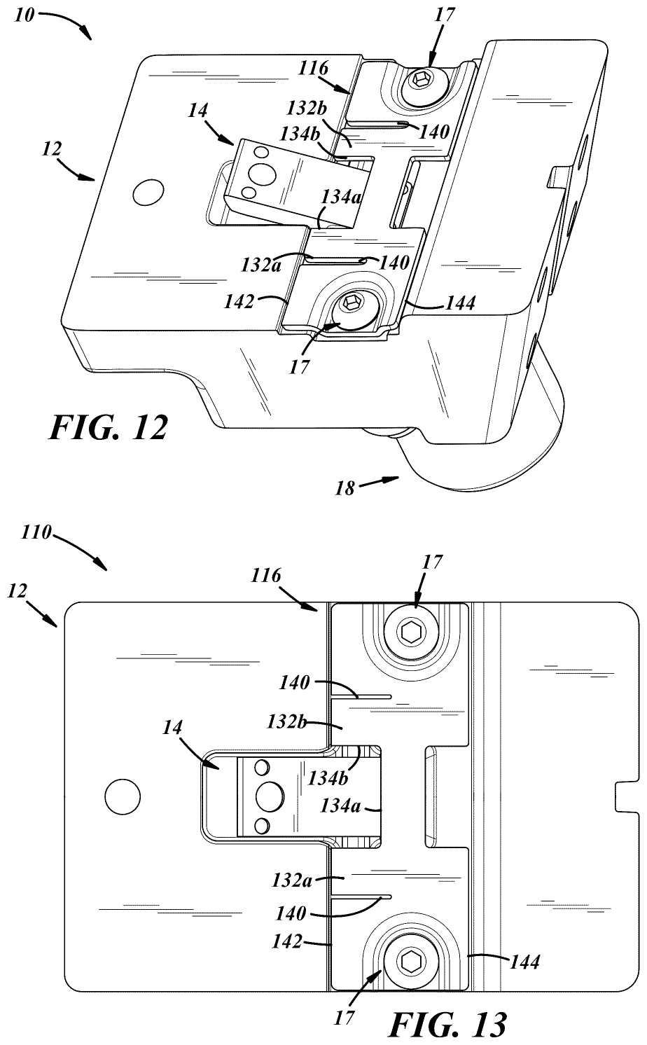

FIGS. 12 through 15 illustrate additional illustrative embodiments of pivotable strut couplers and strut retainers. These embodiments are similar in many respects to the embodiment of FIGS. 1-11. Accordingly, the descriptions of the embodiments are hereby incorporated into one another, and description of subject matter common to the embodiments generally may not be repeated.

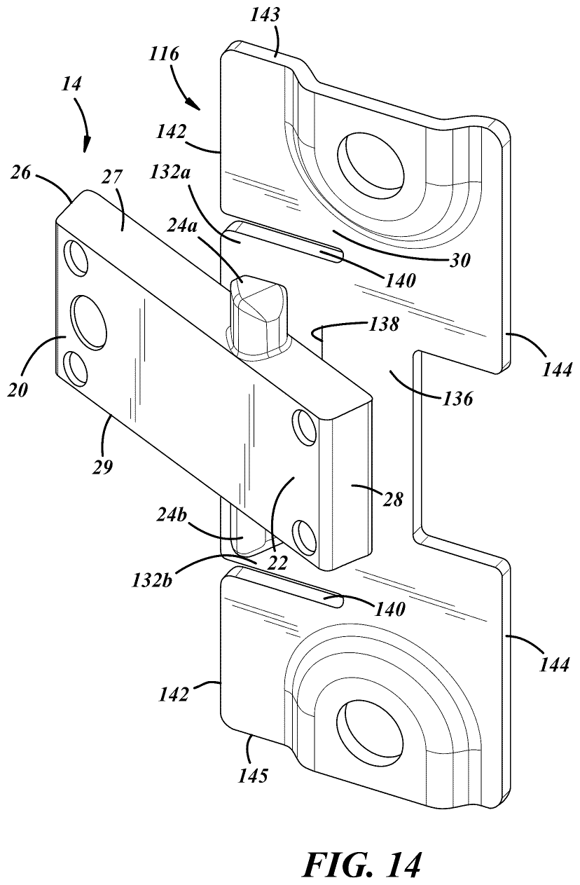

With reference now to FIGS. 12 and 13, another pivotable strut coupler 110 is shown that is nearly identical to the pivotable strut coupler 10 of FIGS. 1-11, except that a strut retainer 116 has weakenings 140 that extend longitudinally, for example, parallel to a longitudinal axis of the strut 14. With additional reference to FIG. 14, the weakenings 140 may be located laterally about half way between laterally opposed edges 134a,b of strut ear retainers 132a,b and centerlines of the strut retainer fasteners 17. More specifically, the weakenings 140 may be located laterally between 20% and 80% of the distance from the laterally opposed edges 134a,b of the strut ear retainers 132a,b to centerlines of the strut retainer fasteners 17 or, more specifically, between 30% and 70% of that distance or, even more specifically between 40% and 60% of that distance. The weakenings 140 may extend longitudinally from a forward edge 142 of the strut retainer 116 toward a rearward edge 144 of the strut retainer 116 and may terminate at about half way between the forward edge 142 and the rearward edge 144. More specifically, the weakenings 140 may extend longitudinally between 20% and 80% of the distance from the forward edge 142 to the rearward edge 144 or, more specifically, between 30% and 70% of that distance or, even more specifically between 40% and 60% of that distance.

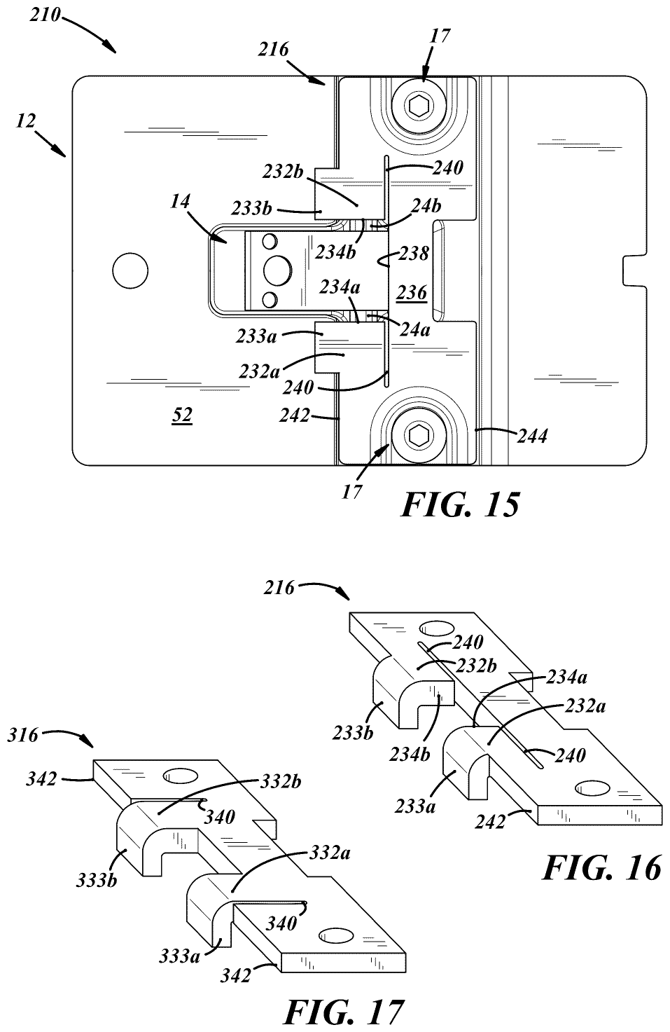

With reference now to FIG. 15, a further pivotable strut coupler 210 is shown that is nearly identical to the pivotable strut coupler 10 of FIGS. 1-11, except, with additional reference to FIG. 16, a strut retainer 216 has strut ear retainers 232a,b with claws or bent tabs 233a,b that may further assist in retaining the ears 24a,b of the strut 14 to the housing 12. The strut ear retainers 232a,b extend longitudinally forward from a forward edge 242 of the strut retainer 216 and the bent tabs 233a,b extend away from an upper surface of the strut retainer 216, for example, downwardly toward the base surface 52 of the housing 12. Although not shown, the base surface 52 of the housing 12 may have reliefs therein to accept distal portions of the bent tabs 233a,b. The weakenings 240 extend laterally and may originate at junctures between laterally inboard edges 234a,b of the strut ear retainers 232a,b and a front edge 238 of a strut body retainer 236.

With reference now to FIG. 17, an additional strut retainer 316 is shown that is nearly identical to the strut retainer 216 of FIGS. 15 and 16, except for weakenings 340 that extend longitudinally and that may originate at junctures between a forward edge 342 of the strut retainer 316 and laterally outboard edges 333a,b of strut ear retainers 332a,b.

As used in herein, the terminology “for example,” “e.g.,” for instance,” “like,” “such as,” “comprising,” “having,” “including,” and the like, when used with a listing of one or more elements, is to be construed as open-ended, meaning that the listing does not exclude additional elements. As used herein, permissive terms like “may” and “can” are expedients merely to indicate optionality, for instance, of a disclosed embodiment, element, feature, or the like, and should not be construed as rendering indefinite any disclosure herein. Moreover, directional words such as front, rear, top, bottom, upper, lower, radial, circumferential, axial, lateral, longitudinal, vertical, horizontal, transverse, and/or the like are employed by way of example and not necessarily limitation, and may be used with respect to a component/product frame of reference and not necessarily with respect to a vehicle frame of reference.

Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. And for the sake of expedience, each explicit illustrative embodiment and modification is hereby incorporated by reference into one or more of the other explicit illustrative embodiments and modifications. As such, many other embodiments, modifications, and equivalents thereto, either exist now or are yet to be discovered and, thus, it is neither intended nor possible to presently describe all such subject matter, which will readily be suggested to persons of ordinary skill in the art in view of the present disclosure. Rather, the present disclosure is intended to embrace all such embodiments and modifications of the subject matter of this application, and equivalents thereto, as fall within the broad scope of the accompanying claims.

1. A pivotable strut coupler, comprising:
a housing including
a base surface, and
a strut pocket in the base surface and having
a forward pocket portion extending along a longitudinal axis,
a rearward pocket portion extending along the longitudinal axis, and
a transverse pocket portion extending transversely with respect to at least one of the forward pocket portion or the rearward pocket portion along a transverse axis;
a strut carried in the strut pocket of the housing and including
a forward body portion carried in the forward pocket portion of the strut pocket of the housing,
a rearward body portion carried in the rearward pocket portion of the strut pocket of the housing,
sides, and
ears extending in directions transversely away from the sides and carried in the transversely extending transverse pocket portion of the strut pocket of the housing; and
a strut retainer coupled to the housing and straddling transversely across a portion of the strut including the ears, wherein the strut retainer includes weakenings to facilitate resilient flexure of the strut retainer.

2. The pivotable strut coupler of claim 1, wherein the weakenings include slots in the strut retainer.

3. The pivotable strut coupler of claim 1, wherein the weakenings extend orthogonally.

4. The pivotable strut coupler of claim 3, wherein the weakenings extend transversely, parallel to the transverse axis.

5. The pivotable strut coupler of claim 3, wherein the weakenings extend longitudinally, parallel to the longitudinal axis.

6. The pivotable strut coupler of claim 1, wherein the housing further includes a spring pocket in the forward pocket portion of the strut pocket.

7. The pivotable strut coupler of claim 1, wherein the housing further includes an armature passage in the rearward pocket portion of the strut pocket.

8. The pivotable strut coupler of claim 7, further comprising:
an actuator coupled to the housing and including an armature extending into the armature passage of the housing to engage the rearward body portion of the strut.

9. The pivotable strut coupler of claim 8, wherein the actuator includes an electromechanical solenoid.

10. The pivotable strut coupler of claim 1, wherein the strut retainer is fastened to the housing.

11. The pivotable strut coupler of claim 1, wherein the strut retainer further includes strut ear retainers at least partially defined by the weakenings and having a rest position, and wherein the weakenings facilitate resilient and substantial return of the strut ear retainers back to their rest position after hyperextension of the strut.

12. The pivotable strut coupler of claim 11, wherein the weakenings facilitate elastic deformation of the strut ear retainers of at least 60% recovery of the strut ear retainers back toward their rest position.

13. A pivotable strut retainer, comprising:
strut ear retainers including laterally opposed edges establishing a pivotable strut opening;
a strut body retainer including a front edge transversely extending between the laterally opposed edges of the strut ear retainers; and
weakenings at least partially defining the strut ear retainers to facilitate resilient flexure of the strut ear retainers.

14. The pivotable strut retainer of claim 13, wherein the weakenings include slots in the pivotable strut retainer.

15. The pivotable strut retainer of claim 13, wherein the weakenings extend orthogonally.

16. The pivotable strut retainer of claim 15, wherein the weakenings extend transversely.

17. The pivotable strut retainer of claim 15, wherein the weakenings extend longitudinally.

18. The pivotable strut retainer of claim 13, further comprising a forward edge, a rearward edge, and side edges extending between the forward and rearward edges, wherein the strut ear retainers extend longitudinally forward from the forward edge and the strut ear retainers include bent tabs extending away from an upper surface of the pivotable strut retainer.

19. The pivotable strut retainer of claim 13, wherein the weakenings extend laterally and originate at junctures between laterally inboard edges of the strut ear retainers and a front edge of a strut body retainer.

20. The pivotable strut retainer of claim 13, wherein the weakenings extend longitudinally and originate at junctures between a forward edge of the pivotable strut retainer and laterally outboard edges of the strut ear retainers.
